(19) United States
(12) Patent Application Publication
(10) Pub. No.: US 2008/0117856 A1
(43) Pub. Date: May 22, 2008

(54) MULTI-PHASE FRAME STRUCTURE TO SUPPORT MULTI-HOP WIRELESS BROADBAND ACCESS COMMUNICATIONS

(76) Inventors: Wendy C. Wong, San Jose, CA (US); Jaroslaw J. Sydir, San Jose, CA (US); Hyunjeong Hannah Lee, Hillsboro, OR (US); Kerstin Johnsson, Palo Alto, CA (US)

Correspondence Address: INTEL CORPORATION;c/o INTELLEVATE, LLC, P.O. BOX 52050, MINNEAPOLIS, MN, 55402, US

(21) Appl. No.: 11/923,566

(22) Filed: Oct. 24, 2007

Related U.S. Application Data
(60) Provisional application No. 60/854,465, filed on Oct. 25, 2006.

(51) Int. Cl. H04B 7/14

(52) U.S. Cl. 370/315; 375/211

(57) ABSTRACT

A wireless device to configure a frame structure with multiple phases to support any hop network and any number of Relay Stations (RSs) deployed without increasing overhead proportionally with the number of RSs deployed in the system.

The present application claims priority to U.S. Patent Application No. 60/854,465, filed Oct. 25, 2006, entitled “Multi-Phase Frame Structure to Support Multi-Hop Wireless Broadband Access Communications,” the entire disclosure of which is hereby incorporated by reference in its entirety.

Developments in a number of different digital technologies have greatly increased the need to transfer data from one device across a network to another system. Technological developments permit digitization and compression of large amounts of voice, video, imaging, and data information, which may be transmitted from laptops and other digital equipment to other devices within the network. These developments in digital technology have stimulated a need to deliver and supply data to these processing units.

It is becoming increasingly attractive to use wireless nodes in a wireless network as relaying points to extend range and/or reduce costs of a wireless network. A Multi-hop Relay (MR) network may use fixed and/or mobile stations as relaying points to optimize communications and increase the efficiency of transmissions. One notable issue is how to coordinate the selection of optimal transmission paths using new protocols and architectures and reduce costs associated with these networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram illustrating an arrangement of wireless nodes in an example wireless network for explicitly conveying multi-hop link information according to one embodiment of the present invention; and

FIG. 2 is an embodiment of a frame structure with multiple phases that is dynamically adjusted to support any hop network and any number of Relay Stations (RSs) deployed in the system.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Wireless multi-hop relay systems have become the focus of several current standardization efforts. For example, for WLANs the Institute of Electrical and Electronics Engineers (IEEE) 802.11s Mesh Task Group (TG) is actively working on standard solutions for WLAN mesh networking. Additionally, the IEEE 802.16j Multi-hop Relay (MR) task group is also evaluating solutions for standardization in furtherance of the IEEE 802.16j project approval request for wireless broadband access (WBA) networks.

The multi-hop relay systems provide a cost effective way for multi-media traffic to increase in range. The relay stations offer extended coverage through existing networks and the MR system is a cost effective solution accommodating many mobile subscribers, establishing wide area coverage and providing higher data rates. Thus, the multi-hop relay systems enhance throughput and capacity for 802.16 systems and enable rapid deployment which reduces the cost of system operation.

MR relay stations are intended to be fully backward compatible in the sense that they should operate seamlessly with existing 802.16e subscriber stations. A further phase of 802.16 is expected to introduce enhanced relay and WBA subscriber stations designed for use in MR networks. While the embodiments discussed herein may refer to 802.16 wireless broadband access networks, sometimes referred to as WiMAX, an acronym that stands for Worldwide Interoperability for Microwave Access, which is a certification mark for products that pass conformity and interoperability tests for the IEEE 802.16 standards, they are not so limited and may be applicable to WLAN, other types of mesh networks or even combinations of different networks. Multi-hop relay techniques may be applied to other emerging standards such as 3rd Generation Partnership Project (3GPP) for the Long Term Evolution (LTE).

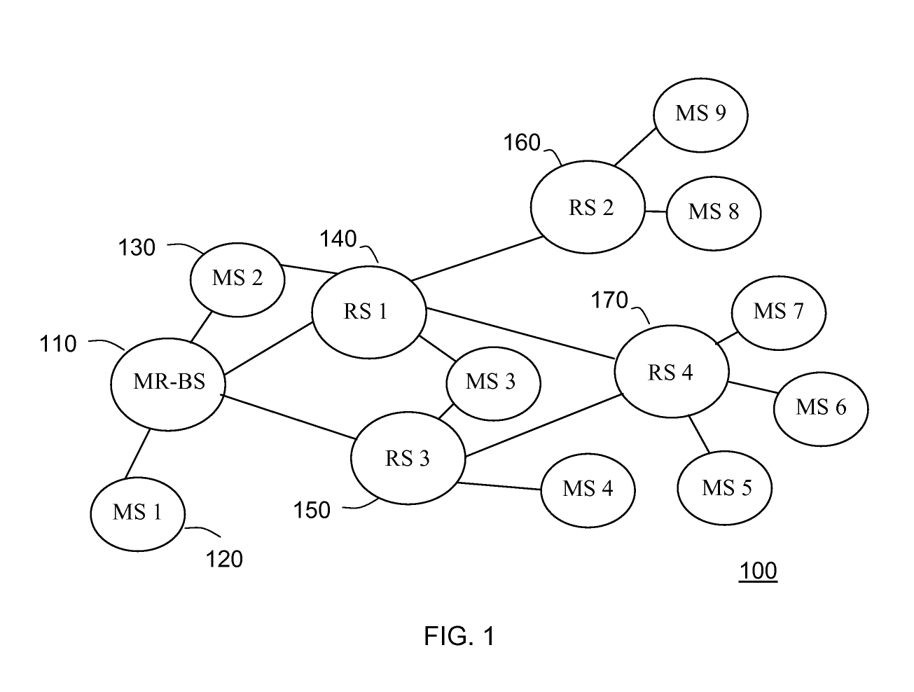

FIG. 1 is a diagram illustrating an arrangement of wireless nodes in an example wireless network for conveying multi-hop link information according to one embodiment of the present invention. A Multi-hop Relay (MR) network 100 may be any system having devices capable of transmitting and/or receiving information via at least some Over-The-Air (OTA) Radio Frequency (RF) links. For example in one embodiment, the topology of MR network 100 may include an MR Base Station (MR-BS) 110 that provides direct access to multiple Mobile Stations (MSs) 120 and 130. MR-Base Station 110 also connects to a plurality of unwired relay nodes shown as Relay Stations (RS) 140 and 150 in the figure.

Relay Stations (RSs) 140 and 150 wirelessly communicate and relay messages in MR network 100 using wireless protocols and/or techniques compatible with one or more of the various 802 wireless standards for WPANs and/or standards for WMANs, although the inventive embodiments are not limited in this respect. As illustrated in the figure, Relay Stations (RSs) 140 and 150 provide access to Mobile Stations 120 and 180 as well as relay data on behalf of other RSs. In certain non-limiting example implementations of the inventive embodiments, the topology illustrated is tree-like with the MR-BS at the root and MSs at the leaves to provide multiple communication paths or links. Access links provide the supported paths between the MR-BS and the MS and further between the RS and the MS. Relay links provide the support paths between the MR-BS and the RSs.

MR network 100 may be comprised of several macro cells, each of which may generally comprise at least one base station similar to MR base station 110 and a plurality of relay stations similar to RSs 140 and 150 dispersed throughout each macro cell and working in combination with the base station(s) to provide a full range of coverage to client stations. The multi-hop topology between MR-BS 110 and RSs 140 and 150 can be viewed as a Point-to-Multipoint (PMP) link. Further, RS 140 is connected to RS 160 and RS 170 via a PMP link, where each PMP link relies on the stations to maintain time and frequency synchronization that is performed via the broadcast and reception of a downlink (DL) preamble, whereas uplink (UL) synchronization is performed by a ranging process.

MR network 100 utilizes a frame structure which allows multiple relay links to share a channel, and thus, multiple PMP links may be supported on the same channel. When multiple PMP links share a channel, the stations that participate in the links synchronize and data is transmitted to minimize interference. The frame structure is configurable to optimize the topology and the requirements for deployment and allow the multiple PMP links to share the channel while utilizing a combination of time division multiplexing (TDM) and spatial reuse.

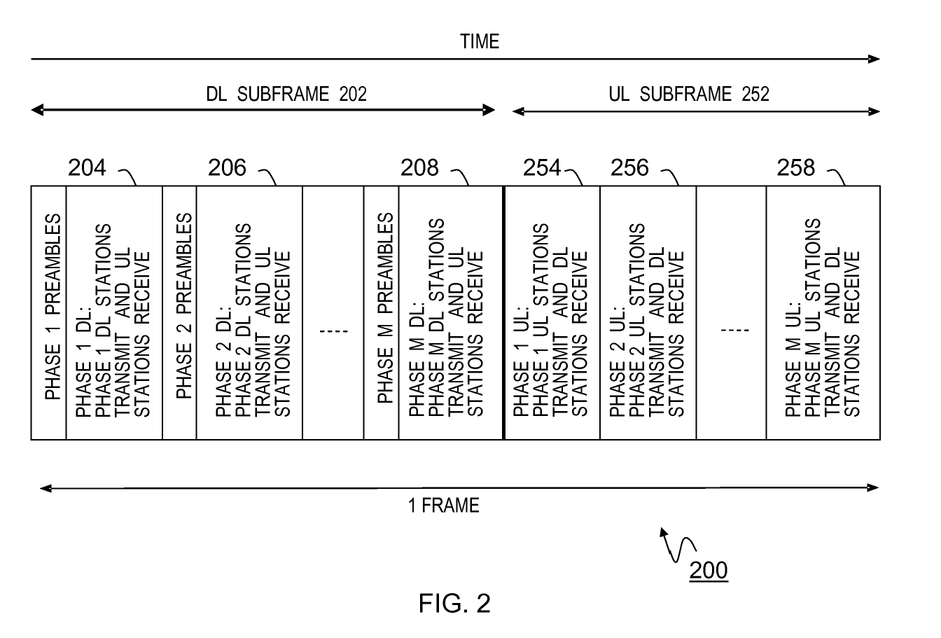

FIG. 2 illustrates a frame structure 200 for relay links for TDD operations. TDD makes efficient use of spectrum by using a frequency channel that is assigned to both the transmitter and the receiver. TDD is suited to the transport of asymmetric traffic that utilizes both an uplink (UL) and a downlink (DL) traffic using the same frequency f₀ but at different times. In effect, TDD divides the data stream into frames and, within each frame assigns different time slots to the forward and reverse transmissions. The frame structure allows both types of transmissions to share the same transmission medium while using only the part of the bandwidth required by each type of traffic.

The figure shows a TDD frame divided into a DL subframe 202 and a UL subframe 252, with each of the DL and UL subframes further divided into a number of phases. The DL subframes and the UL subframes are divided into time slots and each type of traffic (UL traffic and DL traffic) is allocated several time slots at a time within the frame. Note that each DL phase in DL subframe 202 has a corresponding UL phase in UL subframe 252 such that the number of DL phases is the same as the number of UL phases. Specifically, the number of DL phases in DL subframe 202 represented by DL phases 204, 206, and . . . 208 matches the number of UL phases in UL subframe 252 represented by UL phases 254, 256, and . . . 258. Further note that the first symbol in each DL phase is a preamble.

Each of the relay PMP links (e.g., the link between MR-BS 110 and RSs 140 and 150 and the link between RS 140 and RSs 160 and 170) are assigned to a phase. As previously mentioned, MR-BS 110 is located at the root of a PMP link and is the DL station for that link. As such, MR-BS 110 becomes one of the DL stations and transmits preambles, MAPS and data in the DL portion of the phase to which the PMP link is assigned. Also as previously mentioned, the leaves of the PMP link described in this example as RS 140 and RS 150 are UL stations that transmit data in the UL portion of the phase. More than one PMP link can be assigned to a given phase.

The number of phases in the relay link frame structure may be dynamically selected as part of the frequency planning and deployment process. Accordingly, the structure of the relay link frame structure may be adjusted or altered during the operation of the system. Frame structure 200 is divided into multiple phases to allow multiple PMP links to share the channel in TDM fashion, thereby protecting preamble transmissions from excessive interference. The structure of frame structure 200 allows PMP links that share a channel to be partitioned into separate groups, where each group is assigned to a phase.

All RSs that are DL stations in a phase transmit their preamble in the DL portion of that phase. All preambles within a phase are transmitted in the same symbol, so assigning two RSs to be DL stations in a phase causes them to transmit their preambles at the same time. In general, stations are assigned to be DL stations in the same phase if they will not generate too much interference for other stations in that phase. An RS cannot be scheduled to receive on the DL and transmit on the UL in the phase in which it is a DL station. However, an RS can receive on the DL or UL in multiple phases.

Multi-phase frame structure 200 may be used to assign DL transmitters to phases in a variety of ways. In a 2-hop topology that only includes one tier of RSs that are one hop away from the MR-BS, only one phase is included to support relay link communication. However, a two phase structure may be used to support a multi-hop topology by assigning the stations to phases based on their distance in hops from the MR-BS. Stations that are an even number of hops from the MR-BS are assigned to one phase while stations that are an odd number of hops from the MR-BS are assigned to the other phase.

Alternatively, the multi-phase frame structure 200 may be used to distribute RSs into more than two phases in order to avoid interference among multiple RSs by placing them into different phases, while enabling spatial reuse between RSs that are placed in the same phase. The nature of frame structure 200 allows the network provider to select the number of phases based on the specific topology and requirements of the MR cell and dynamically configure frame structure 200 to make the tradeoff between overhead and performance on a “per deployment” basis. More phases may be added to frame structure 200 to reduce co-channel interference at the cost of more overhead, whereas fewer phases may be used if the interference among RSs is tolerable. Frame structure 200 may be used to support multi-hop communications over a single channel. It can also be used to separate the broadcast transmissions of RSs that interfere, while still allowing them to share the resources of one channel. Multiple RSs may be assigned to the same phase to facilitate spatial reuse between RSs that are not expected to interfere with each other.

In the FDD version of the frame structure for relay links the DL subframe takes up the entire frame in the channel which is dedicated to the DL direction and the UL subframe takes up the entire frame in the channel that is dedicated to the UL direction.

Whereas prior art schemes have either assumed two-hop topologies or have assumed a hard coded TDM partitioning with a partition (phase) for each hop, the present invention configures a frame structure with multiple phases which can support any hop network and any number of RSs deployed in the system without increasing overhead proportionally with the number of RSs deployed in the system. By now it should be apparent that a frame structure has been described that may be dynamically configured for a WiMAX multi-hop wireless relay deployment.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method of providing a multi-hop wireless relay deployment, comprising:
dynamically configuring a frame structure with multiple phases to support a multi-hop network having multiple Relay Stations (RSs) deployed in a system.

2. The method of claim 1 further including:
selecting a number of phases in the relay link frame structure and a size of the phases as part of a frequency planning and deployment process.

3. The method of claim 1 further including:
dynamically adjusting the frame structure during operation of the system to include an additional RS in a multi-hop wireless network.

4. The method of claim 1 further including:
assigning more than one Point-to-Multipoint (PMP) link to a phase.

5. The method of claim 1 further including:
distributing RSs into more than two phases in order to avoid interference among multiple RSs by placing them into different phases while enabling spatial multiplexing between RSs that are placed in the same phase.

6. A WiMAX multi-hop wireless relay deployment system, comprising:
a Multi-hop Relay Base Station (MR-BS); and
multiple Relay Stations (RSs) deployed in the system to communicate using a multi-phase frame structure to assign downlink transmitters to phases based on their distance in hops from the MR-BS, where RSs that are an even number of hops from the MR-BS are assigned to one phase while RSs that are an odd number of hops from the MR-BS are assigned to the other phase.

7. The system of claim 6 wherein the system is dynamically configured to adjust the multi-phase frame structure during operation of the system to include an additional number of RS in a multi-hop wireless network.

8. The system of claim 6 wherein the system configures the multi-phase frame structure with multiple phases to support any number of RSs deployed in the system without increasing overhead proportionally with the number of RSs deployed in the system.

9. The system of claim 6 wherein the system configures the multi-phase frame structure into more than two phases in order to avoid interference among multiple RSs by placing them into different phases.

9. The system of claim 6 wherein the multi-phase frame structure has a downlink subframe and an uplink subframe.

10. The system of claim 9 wherein the downlink subframe includes a first preamble followed by a first phase downlink for stations to transmit and an uplink for stations to receive.

11. The system of claim 10 wherein the downlink subframe includes a second preamble followed by a second phase downlink for stations to transmit and an uplink for stations to receive.

12. The system of claim 9 wherein the uplink subframe includes a first phase uplink for stations to transmit and a downlink for stations to receive.

13. The system of claim 12 wherein the uplink subframe includes a second phase uplink for stations to transmit and a downlink for stations to receive.

14. A WiMAX multi-hop wireless relay deployment system, comprising:
a Multi-hop Relay Base Station (MR-BS); and
multiple Relay Stations (RSs) deployed in the system to communicate using a multi-phase frame structure the multi-phase frame structure to distribute RSs into more than two phases in order to avoid interference among multiple RSs, while enabling spatial reuse between RSs that are placed in a same phase.

15. The WiMAX multi-hop wireless relay deployment system of claim 14 wherein a network provider selects a number of phases based on a specific topology and requirements of multi-hop relay cells.

16. The WiMAX multi-hop wireless relay deployment system of claim 14 wherein a network provider dynamically configures the multi-phase frame structure to tradeoff between overhead and performance on a deployment basis.

17. The WiMAX multi-hop wireless relay deployment system of claim 14 wherein a network provider dynamically adds more phases to reduce co-channel interference at the cost of more overhead.
